(19) United States
(12) Patent Application Publication
(10) Pub. No.: US 2008/0032770 A1
(43) Pub. Date: Feb. 7, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/705,769

(22) Filed: Feb. 14, 2007

Related U.S. Application Data
(60) Provisional application No. 60/834,814, filed on Aug. 2, 2006.

(51) Int. Cl. A63F 13/00

(52) U.S. Cl. 463/20

(57) ABSTRACT

The slot machine according to the present invention is a slot machine comprising: a display having a rectangular display area to which a plurality of symbols are to be arranged and two cross lines are at least to be set, each of the cross lines connecting opposite corners of the display area; and a controller, the controller rearranging the plurality of symbols within the display area and setting the two cross lines and rearranging a cross symbol at an intersection of the cross lines when the symbols rearranged on both ends of respective diagonal lines of the display area are the same, the cross symbol allowed to function as two types of symbols rearranged on both ends of the respective cross lines.

### CROSS-REFERENCE TO RELATED APPLICATIONS

This application claims priority of U.S. Provisional Patent Application No. 60/834,814 filed on Aug. 2, 2006. The contents of this application are incorporated herein by reference in their entirety.

### BACKGROUND OF THE INVENTION

1. Field of the Invention

The present invention relates to a slot machine and a playing method thereof.

2. Discussion of the Background

In conventional slot machines, if a player inserts game media such as medals, coins or bills into an insertion slot of the slot machine and pushes a spin button, then a plurality of symbols are displayed in a scrolling manner to a display provided on the front surface of a casing and, thereafter, the respective symbols are automatically stopped, as disclosed in U.S. Pat. Nos. 6,960,133, 6,012,983 and 6,093,102. In this case, when the respective symbols start to be displayed in a scrolling manner by the input through the spin button, symbols are selected using random numbers, and if the combination of the selected symbols is a predetermined winning combination, this causes transition from a basic game to a bonus game (for example, a mystery bonus, a second game and the like) and, then, the bonus game is executed. Further, such slot machines are configured to conduct a payout depending on the winning state occurring along with progression of games.

Further, among conventional slot machines, there are some slot machines which conduct two types of payouts which are payouts determined according to the combinations of symbols rearranged along winning lines and payouts determined according to the number of displayed scatter symbols, as disclosed in U.S. Pat. No. 6,604,999 and US 2002-0065124-A1. In such conventional slot machines, payouts have nothing to do with positions of the winning lines where winning combinations are generated or positions of the displayed scatter symbols, and therefore there are requests for advent of a slot machine having new entertainment characteristics.

The contents of U.S. Pat. Nos. 6,960,133, 6,012,983, 6,093,102 and 6,604,999 and US2002-0065124-A1 are incorporated herein by reference in their entirety.

### SUMMARY OF THE INVENTION

The present invention provides a slot machine having the following configuration.

That is, the slot machine according to the present invention comprises: a display having a rectangular display area to which a plurality of symbols are to be arranged and plurality of winning lines including two cross lines are to be set, each of the cross lines connecting opposite corners of the display area. The above-mentioned slot machine also comprises a controller, the controller rearranging the plurality of symbols within the display area and setting the two cross lines and rearranging a cross symbol at an intersection of the cross lines when the symbols rearranged on both ends of respective diagonal lines of the display area are the same, the cross symbol allowed to function as two types of symbols rearranged on both ends of the respective cross lines.

Further, in addition to the configuration mentioned above, the present invention applies the following configuration.

That is, in the slot machine according to the present invention, the controller further comprises conducting a high payout when a same symbol as the symbols rearranged on both ends of either one of the cross lines is rearranged on the one cross line, the high payout having a higher rate than a payout in an event that the same symbol is rearranged at a position other than the one cross line.

Further, in addition to the configuration mentioned above, the present invention applies the following configuration.

That is, in the slot machine according to the present invention, the controller further comprises holding the cross symbol during a plurality of games. When applying this configuration, the controller may further comprise holding the symbols on both ends of the cross line during a plurality of games.

### BRIEF DESCRIPTION OF THE DRAWINGS

FIG. 1 is a view for illustrating a symbol matrix;

FIG. 2 is a view illustrating a correspondence between winning combinations and payout value;

FIG. 3A is a view illustrating an exemplary symbol matrix;

FIG. 3B is a view illustrating an exemplary symbol matrix;

FIG. 3C is a view illustrating an exemplary symbol matrix;

FIG. 4 is a perspective view schematically illustrating a slot machine according to an embodiment of the present invention;

FIG. 5 is a block diagram illustrating an internal structure of the slot machine illustrated in FIG. 4;

FIG. 6 is a flow chart illustrating a subroutine of slot game execution processing; and

FIG. 7 is a flow chart illustrating a subroutine of symbol rearrangement processing.

### DESCRIPTION OF THE EMBODIMENTS

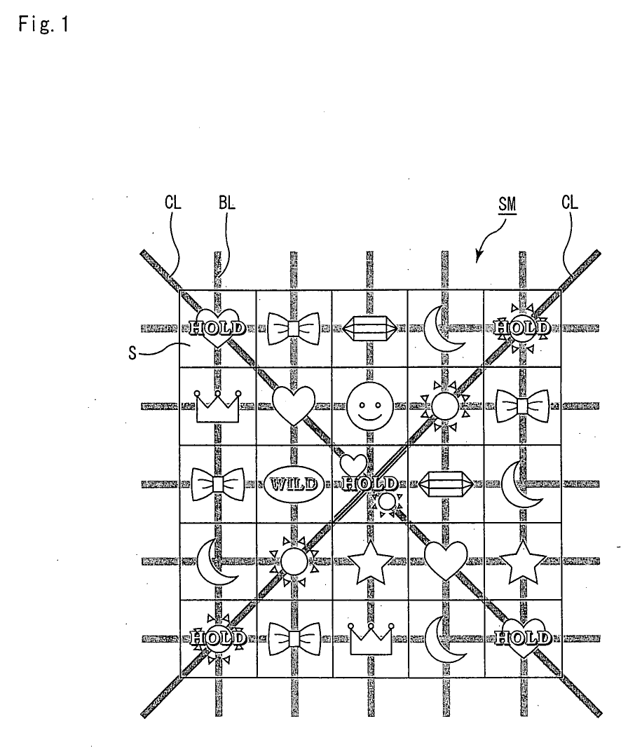

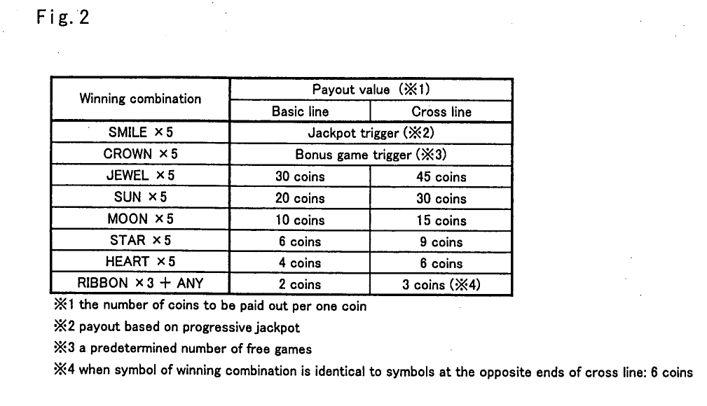

FIG. 1 is a view for illustrating a symbol matrix. FIG. 2 is a view illustrating a correspondence between winning combinations and payout values. A slot machine 10 is a standalone type slot machine that is not connected to a network, but the present invention can also be applied to a slot machine connected to a network.

A symbol matrix SM as illustrated in FIG. 1 is displayed to a lower image display panel 16 included in the slot machine 10 according to the present invention. The symbol matrix SM is constituted by a total of 25 symbols along five columns and five rows. In the symbol matrix SM, 10 basic lines BL are set along the respective columns or the respective rows. Further, in the present specification, the basic lines refer to winning lines other than cross lines. Further, there are set two cross lines CL obliquely across the symbol matrix SM. The winning lines according to the present invention include the basic lines BL and the cross lines CL.

In the present embodiment, there are 9 types of symbols; “SMILE”, “CROWN”, “JEWEL”, “SUN”, “MOON”, “STAR”, “HEART”, “RIBBON” and “WILD”. Depending on the combinations of symbols generated along the winning lines, the payout value is determined. Further, the symbols “HEART” and “SUN” respectively arranged at the opposite ends of each of the cross lines have characters of “HOLD” attached thereon. These symbols are being held and will not be rearranged during plural games. Further, the symbol arranged at the intersection of the cross lines also has the character of “HOLD” attached thereon and is a cross symbol which is allowed to function as the two types of symbols “HEART” and “SUN”.

As illustrated in FIG. 2, “SMILE×5” is a jackpot trigger. If five of the “SMILE” are arranged along a winning line, a payout is conducted based on a progressive jackpot. Since the slot machine 10 is a standalone type slot machine, the payout based on the progressive jackpot is the sum of an accumulated value (a value resulted from accumulation of a portion of the number of inserted game media) in the single slot machine 10 and an initial payout value.

However, in the present invention, the accumulated value used in the event of a progressive jackpot is not limited thereto. For example, in the case where the slot machine is connected to a network, the accumulated value may be an accumulated value in the same type of slot machines in a single casino, an accumulated value in the same type of slot machines in the same area (for example, state or country), or the like.

In the present embodiment, the payout based on a progressive jackpot is conducted in preference to the payout based on other symbols or in preference to bonus games. Accordingly, if both a jackpot trigger and a bonus game trigger are generated at the same time, the payout based on the progressive jackpot is conducted, while no bonus game is executed.

Further, “CROWN×5” is a bonus game trigger. If five of the “CROWN” are arranged along a winning line, then a free game is executed for a predetermined number of times (for example, for ten times). The free games are executed as if the same number of coins as that at the time of generation of the free games have been inserted, even though no coin has been inserted.

The number of coins to be paid out per single inserted coin are set respectively for “JEWEL×5”, “SUN×5”, “MOON×5”, “STAR×5”, “HEART×5” and “RIBBON×3+ANY”. As the respective numbers of coins to be paid out, there are set different values for the case where the symbols are arranged along a basic line and the case where the symbols are arranged along a cross line. The number of coins to be paid out set for the case where symbols are arranged along a cross line is set to 1.5 times the number of coins to be paid out that is set for the case where the symbols are arranged along a basic line.

Further, for “RIBBON×3+ANY”, the number of coins to be paid out when the symbol “RIBBON” in the winning combination is the same as the symbols arranged on both ends of the cross line is set to twice the number of coins to be paid out when it is different from the symbols arranged on both ends of the cross line.

Further, “WILD” is a symbol that can be substituted for any of the symbols.

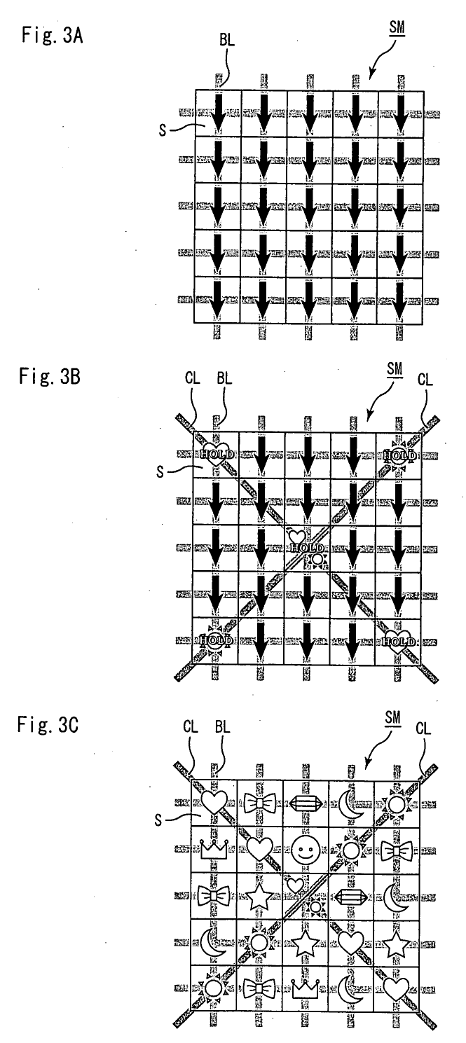

When a game is started, the basic lines BL are set as illustrated in FIG. 3A, and all the symbols within the symbol matrix SM start to be scrolled. In the figure, downward arrows indicate symbols being scrolled. Then, symbols are rearranged at the four corners of the symbol matrix SM. At this time, if the symbols positioned at the opposite corners of the symbol matrix SM are identical, the cross lines CL are set and, also, a cross symbol is rearranged at the intersection of the cross lines CL. The cross symbol CL is allowed to have the function of the two types of symbols rearranged at the opposite ends of the cross lines. For example, if there are a pair of “SUN” symbols and a pair of “HEART” symbols as illustrated in FIG. 3B, the two cross lines CL are set along the respective diagonal lines in the symbol matrix SM and, also, a cross symbol having the functions of the two types of symbols “SUN” and “HEART” is rearranged at the intersection of the cross lines CL. Further, the four symbols at the opposite ends of the cross lines and the cross symbol are held and the character “HOLD” is attached on these respective symbols. The held symbols will not be rearranged during a predetermined number of games (for example, five games), thereafter.

Thereafter, the symbols that are yet to be arranged in the symbol matrix SM are rearranged. At this time, for example, if “SUN×5” is generated along one of the cross lines and “HEART×5” is generated along the other cross line as illustrated in FIG. 3C, a payout is conducted.

The payout value is determined according to the following formula (1).

Payout value=the number of coins to be paid out which corresponds to the winning combination×the number of inserted coins (1)

In the case illustrated in FIG. 3C, if the number of inserted coins is 50, then the payout value is (30+6)×50=1800 (coins).

While, in the examples illustrated in FIGS. 1 to 3, there has been described a case where the display area is a symbol matrix, symbols are not necessarily arranged in a matrix shape in the display area, in the present invention. Provided that symbols are arranged at the four corners of the display area, the other symbols can be arranged at random in the display area. Further, the display area may have a polygonal shape with N angles (N is a natural number equal to or greater than 4). In this case, cross lines are set for the respective pairs of the opposite corners of the polygonal shape with N angles.

While, in the examples illustrated in FIGS. 1 to 3, there has been described a symbol matrix constituted by a total of 25 symbols along five columns and five rows, there is no particular limitation on the number of symbols in cases where the display area is a symbol matrix. Further, in a case where the cross lines can be set and, also, a cross symbol can be arranged at the intersection of the cross lines, the numbers of symbols along the columns and the rows can be made different from each other. The shapes, the types, the number and the like of symbols can be properly changed as required. Further, while, in the examples illustrated in FIGS. 1 to 3, there has been described a case where the payout value is determined according to the winning combinations generated along winning lines, symbols arranged in the display area may include scatter symbols, in the present invention. In this case, the payout value can differ between the case where scatter symbols are arranged along a basic line and the case where the scatter symbols are arranged along a cross line.

In the example illustrated in FIG. 3, there has been described a case where symbols are rearranged at the four corners of the symbol matrix at first and, if the symbols positioned at the opposite corners are of the same type, the cross lines are set along the diagonal lines of the symbol matrix and thereafter, symbols that are yet to be arranged are rearranged. However, in the present invention, the way of rearrangement of symbols is not limited to the aforementioned example and, for example, all symbols included in the symbol matrix can be rearranged at the same time and, thereafter, in determining the payout value, the cross lines can be set on the condition that the symbols at the opposite corners are of the same type. Also, the cross lines can be set all the time during the execution of games. Also, for example, the cross lines can be set at predetermined intervals or set for every predetermined number of games, regardless of the combinations of symbols at the opposite corners.

In the example illustrated in FIG. 3, there has been described a case where the condition necessary for setting the cross lines is that the symbols at the opposite ends of the respective diagonal lines of the symbol matrix are identical. However, in the present invention, in cases where the cross lines are set depending on the combinations of symbols at both ends of the respective diagonal lines, the condition necessary for setting cross lines is not limited to the aforementioned example. The condition necessary for setting cross lines may be the following conditions (I) to (VI), for example.

(I) The symbols positioned at the opposite ends of at least a single diagonal line of a symbol matrix are identical.

(II) The aforementioned condition (I) is satisfied and also these symbols are a predetermined symbol.

(III) All the symbols positioned at the opposite ends of the two diagonal lines of the symbol matrix are identical.

(IV) The aforementioned condition (III) is satisfied and also these symbols are a predetermined symbol.

(V) The symbols at both ends of the respective diagonal lines of the symbol matrix are identical and, also, the respective symbols are predetermined symbols.

(VI) The symbols at the opposite ends of the respective diagonal lines of the symbol matrix are identical and, also, the combination of the respective symbols is a predetermined combination.

Also, the cross lines can be set, when the aforementioned conditions necessary for setting cross lines are satisfied and, also, the number of BETs is equal to or greater than a predetermined value.

While, in the example illustrated in FIG. 3, there has been described a case where the two cross lines are set when the condition necessary for setting cross lines is satisfied, there is no particular limitation on the number of cross lines to be set when the conditions necessary for setting cross lines are satisfied.

While, in the example illustrated in FIG. 3, there has been described a case where no winning line is set along the diagonal lines of the display area when the condition necessary for setting cross lines is not satisfied, the present invention is not limited thereto and, for example, basic lines can be preliminarily set along the diagonal lines of the display area and, if the conditions necessary for setting cross lines are satisfied, the preliminarily set basic lines can be changed to cross lines.

In the examples illustrated in FIGS. 1 to 3, there has been described a case where a constant number of basic lines are set regardless of the number of BETs and the payout value at the time when a winning combination is generated is determined based on the number of coins to be paid out set for the winning combination and the number of BETs. However, the present invention is not limited to the example and, for example, the number of basic lines can be varied depending on the number of BETs or the payout value based on generation of a winning combination can be constant regardless of the number of BETs.

In the examples illustrated in FIGS. 1 to 3, there has been described a case where the number of coins to be paid out in the event of generation of a winning combination along a cross line is 1.5 times the number of coins to be paid out in the event of generation of the winning combination along a basic line. However, the present invention is not limited to the example. For example, the number of coins to be paid out in the event of generation of a winning combination along a cross line is the same as the number of coins to be paid out in the event of generation of the winning combination along a basic line and, also, a bonus game can be executed in the event of generation of a winning combination along a cross line and, for example, free games, second games and the like can be executed in the event of generation of a winning combination along a cross line.

While, in the examples illustrated in FIGS. 1 to 3, there have been described cases where the cross symbol is allowed to have the function of the two types of the symbols arranged at the opposite ends of the cross lines, the number of functions provided to a cross symbol is not limited to the cases in the present invention. For example, a cross symbol can be provided with the function of other symbols, as well as the function of two types of symbols arranged at the opposite ends of the cross lines. Also, in a case of applying the configuration to hold the cross symbol to the slot machine, the symbols at the opposite ends of the cross lines can be also held.

Further, while, in the examples illustrated in FIGS. 1 to 3, there have been described cases where the cross symbol and the symbols at the opposite ends of the cross lines are held during a predetermined number of games (five games), the present invention is not limited to the cases. For example, the number of games during which symbols are held can be determined using random numbers. Also, the number of games during which symbols are held can be determined according to the symbols at the opposite ends of the cross lines. Also, the number of games during which symbols are held can be determined individually for the respective cross lines.

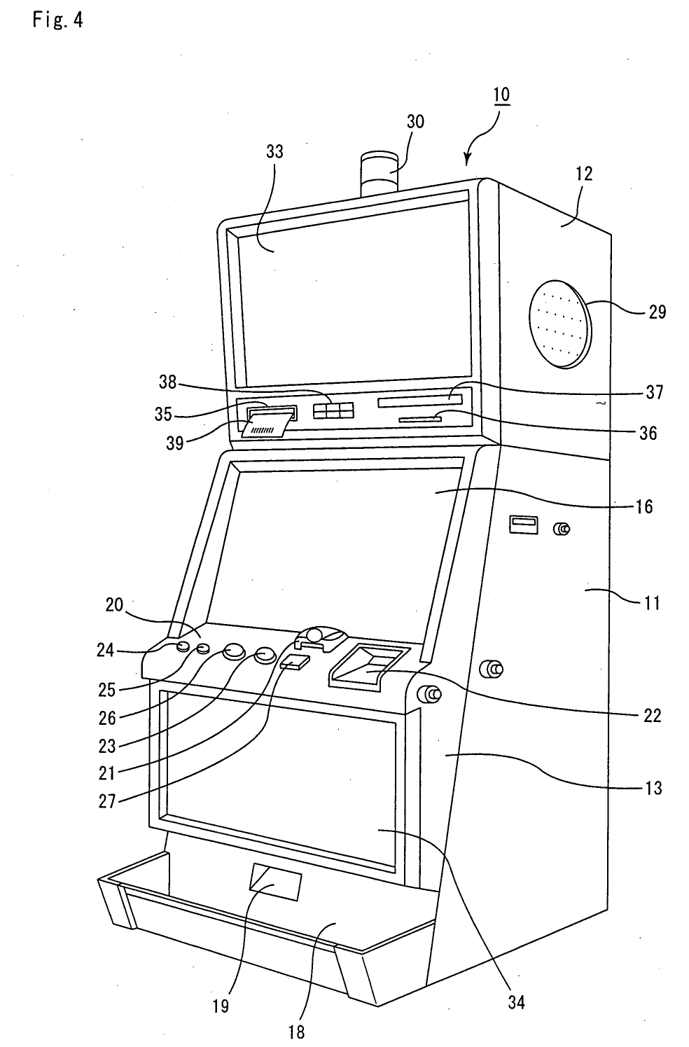

FIG. 4 is a perspective view schematically illustrating a slot machine according to an embodiment of the present invention.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel which displays a symbol matrix SM (see FIGS. 1 and 3) constituted by a total of 5×5=25 symbols. The lower image display panel 16 is the display of the present invention. In the lower image display panel 16, there are provided a number-of-credits display section 31 and a number-of-payouts display section 32 (not shown in the figure). The number-of-credits display section 31 displays an image indicating the number of credited coins. The number-of-payouts display section 32 displays an image indicating the number of coins as the payout.

Further, a touch panel 69, which is not shown in the figure, is provided on the front face of the lower image display panel 16 and the player can input various kinds of commands by operating the touch panel 69.

Provided below the lower image display panel 16 are: a control panel 20 constituting of plural buttons 23 to 27 which are input by the player, commands associated with progress of the game; a coin receiving slot 21 accepting coins into the cabinet 11; and a bill validator 22.

The control panel 20 is provided with: a start button 23; a change button 24; a CASHOUT button 25; a 1-BET button 26; and a maximum BET button 27. The start button 23 is used for inputting a command to start the game. The change button 24 is used in a case where a player requests an attendant of a recreation facility to exchange money. The CASHOUT button 25 is used for inputting a command to pay out credited coins to a coin tray 18.

The 1-BET button 26 is used for inputting a command to bet one coin of the credited coins. The maximum BET button 27 is used for inputting a command to bet the maximum number of coins that can be bet on one game (50 coins in the present embodiment) of the credited coins.

The bill validator 22 is used not only for discriminating a false note from a true note but also for accepting the true note into the cabinet 11. The bill validator 22 may be configured such that a ticket 39 with a bar code which will be described later can be read. A belly glass 34 on which characters and the like of the slot machine 10 are depicted is provided on the front face of the lower portion of the main door 13, that is, below the control panel 20.

On a front surface of the top box 12, an upper image display panel 33 is provided. The upper image display panel 33 includes a liquid crystal display panel which displays, for example, images introducing the contents of games and explaining the rules of games.

A speaker 29 is provided in the top box 12. A ticket printer 35, a card reader 36, a data display 37 and a key pad 38 are provided beneath the upper image display panel 33. The ticket printer 35 prints on a ticket a bar code in which data such as the number of credits, date, time, identification number of the slot machine 10 and the like are encoded, and outputs the ticket 39 with a bar code. A player can make the ticket 39 with a bar code to be read by a second slot machine and play a game in the second slot machine, or exchange in a predetermined place (for example, at a cashier in the casino) of a recreation facility the ticket 39 with a bar code to notes and the like.

The card reader 36 is used for reading data from a smart card and writing data onto a smart card. The smart card is a card to be carried by a player, and for example, data to identify a player and data concerning a history of a game played by a player are stored thereon. Data corresponding to a coin, a note or a credit may also be stored on the smart card. As an alternative of a smart card, a magnetic stripe card may be adopted. The data display 37 is made of a fluorescent display and the like, and it is used, for example, to display data read by the card reader 36 and data input by a player through the key pad 38. The key pad 38 is used for inputting a command or data to issue a ticket and the like.

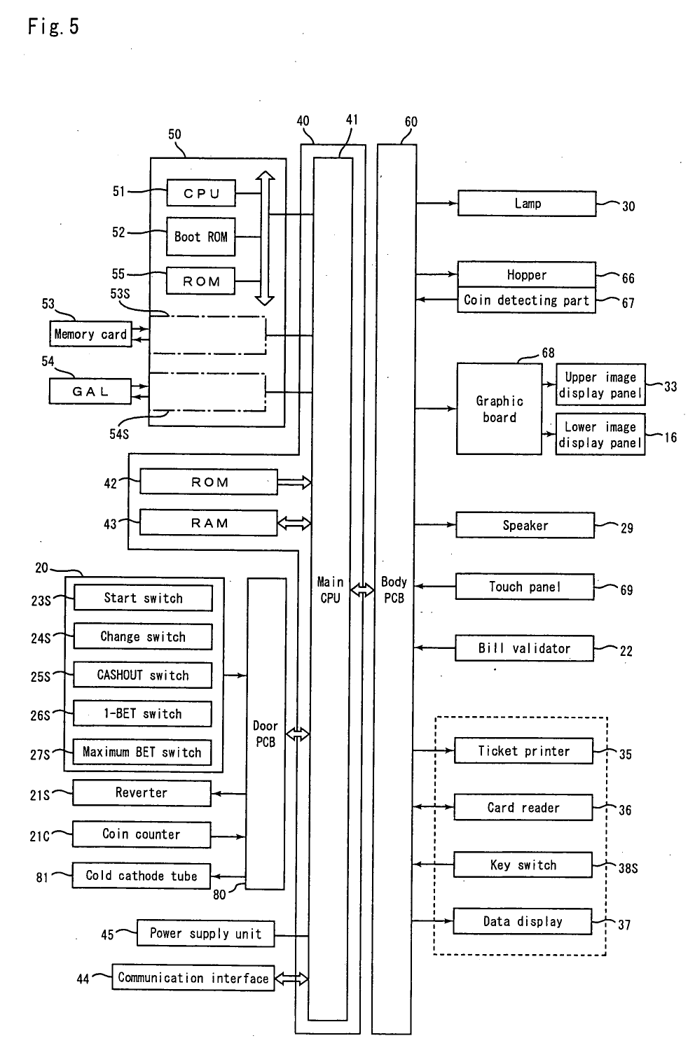

FIG. 5 is a block diagram showing the internal construction of the slot machine shown in FIG. 4.

A gaming board 50 includes: CPU (Central Processing Unit) 51, ROM 55 and boot ROM 52 which are interconnected to one another by an internal bus; a card slot 53S which accepts a memory card 53; an IC socket 54S which accepts GAL (Generic Array Logic) 54.

The memory card 53 is formed from a nonvolatile memory such as CompactFlash (registered trademark) and stores game programs and game system programs. The game programs include a symbol selection program. The aforementioned symbol selection program is a program for determining the symbols to be rearranged in a symbol matrix. The aforementioned symbol selection program includes symbol weighing data in association with plural types of payout ratios (for example, 80%, 84%, 88%). The symbol weighing data is data indicating the correspondence between respective symbols and one or more random numbers which fall in a predetermined numerical range (0 to 255). The payout ratios are determined based on payout-ratio setting data output from the GAL 54 and, based on the symbol weighing data associated with the payout ratios, the symbols to be rearranged in the symbol matrix are determined. Further, the game programs include table data (see FIG. 2) indicating the correspondence between symbols and payout values.

Further, the card slot 53S is configured to allow the memory card 53 to be inserted thereinto or ejected therefrom and is connected to a mother board 40 through an IDE bus. Accordingly, the memory card 53 can be ejected from the card slot 53S, then other game programs and other game system programs can be written into the memory card 53 and then the memory card 53 can be inserted into the card slot 53S to change the types and contents of games played in the slot machine 10. The game programs include programs relating to progression of games. Further, the game programs include image data and sound data to be output during games. The image data includes image data and the like indicating a symbol matrix.

The GAL 54 is a type of PLD having a fixed OR array structure. The GAL 54 includes plural input ports and plural output ports and, if predetermined data is input to an input port, the GAL 54 outputs data corresponding to the aforementioned data from an output port. The data output from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

CPU 51, ROM 55 and boot ROM 52 interconnected to each other by the internal bus are connected to the mother board 40 by PCI bus.

The mother board 40 is constructed with a general-purpose mother board commercially available (a printed circuit board on which basic parts of a personal computer are mounted) and includes: a main CPU 41; ROM (Read Only Memory) 42; RAM (Random Access Memory) 43 and a communication interface 44. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41. RAM 43 can also store the game program. RAM 43 further stores data on the number of credits, the number of coin-in or coin-out for one game, and the like.

Both a body PCB (Printed Circuit Board) 60 and a door PCB 80 which will be described later are connected to the mother board 40 by USB. A power supply unit 45 is also connected to the mother board 40.

Equipment and devices which generate input signals to be input to the main CPU 41, and equipment and devices of which operations are controlled by a control signal output from the main CPU 41 are connected to the body PCB 60 and the door PCB 80. The main CPU 41 executes a game program stored in RAM 43 based on an input signal input to the main CPU 41, and thereby performs a predetermined computational processing, stores results thereof into RAM 43 and transmits a control signal to each equipment and device as a control processing for each of the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37 are connected to the body PCB 60. The lamp 30 is lit up in a predetermined pattern based on a control signal output from the main CPU 41.

The hopper 66 is installed in the cabinet 11 and pays out a predetermined number of coins from a coin payout exit 19 to a coin tray 18 based on a control signal output from the main CPU 41. A coin detecting section 67 is installed inside the coin payout exit 19 and when detecting that a predetermined number of coins has been paid out from the coin payout exit 19, outputs an input signal to the main CPU 41.

The graphic board 68 controls, based on a control signal output from the main CPU 41, image displays on the upper image display panel 33 and the lower image display panel 16. The number of credits stored in RAM 43 is displayed on the number-of-credits display section 31 (not shown in the figure) of the lower image display panel 16. The number of coin-out is displayed on the number-of-payouts display section 31 (not shown in the figure) of the lower image display panel 16. The graphic board 68 is equipped with VDP (Video Display Processor) which generates image data based on a control signal output from the main CPU 41 and a video RAM which temporarily stores image data generated by VDP, and of the like equipments. Note that image data used in generating image data with VDP is contained in a game program read from the memory card 53 and stored in RAM 43.

The bill validator 22 not only discriminates a true note from a false note, but also accepts the true note into the cabinet 11. The bill validator 22, when accepting a true note, outputs an input signal to the main CPU 41 based on a face amount of the note. The main CPU 41 stores in RAM 43 the number of credits corresponding to the amount of the note transmitted with the input signal.

The ticket printer 35, based on a control signal output from the main CPU 41, prints on a ticket a bar code obtained by encoding data such as the number of credits, date and time, the identification number of the slot machine 10, and of the like data stored in RAM 43, and outputs the ticket as the ticket 39 with a bar code.

The card reader 36 transmits to the main CPU 41 data read from the smart card and writes data onto the smart card based on a control signal from the main CPU 41. The key switch 38S is provided on the key pad 38, and when the key pad 38 is operated by a player, outputs a predetermined input signal to the main CPU 41. The data display 37 displays, based on a control signal output from the main CPU 41, data read by the card reader 36 and data input by a player through the key pad 38.

The control panel 20, a reverter 21S, a coin counter 21C and a cold cathode tube 81 are connected to the door PCB 80. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by a player, each of the switches 23S to 27S corresponding thereto outputs input signals to the main CPU 41.

The coin counter 21C is installed inside the coin receiving slot 21, and discriminates whether a coin inserted by a player into the coin receiving slot 21 is true or false. Coins other than the true ones are discharged from the coin payout exit 19. The coin counter 21C also outputs an input signal to the main CPU 41 when a true coin is detected.

The reverter 21S operates based on a control signal output from the main CPU 41 and distributes coins recognized by the coin counter 21C as true coins into a cash box (not shown in the figure) or the hopper 66, which are disposed in the slot machine 10. In other words, when the hopper 66 is filled with coins, true coins are distributed by the reverter 21S into the cash box. On the other hand, when the hopper 66 is not filled with coins, true coins are distributed into the hopper 66. The cold cathode tube 81 works as a backlight installed on the back face sides of the lower image display panel 16 and the upper image display panel 33 and is lit up based on a control signal output from the main CPU 41.

Next, description will be given of a processing performed in the slot machine 10.

The main CPU 41 reads and executes the game program to progress a game.

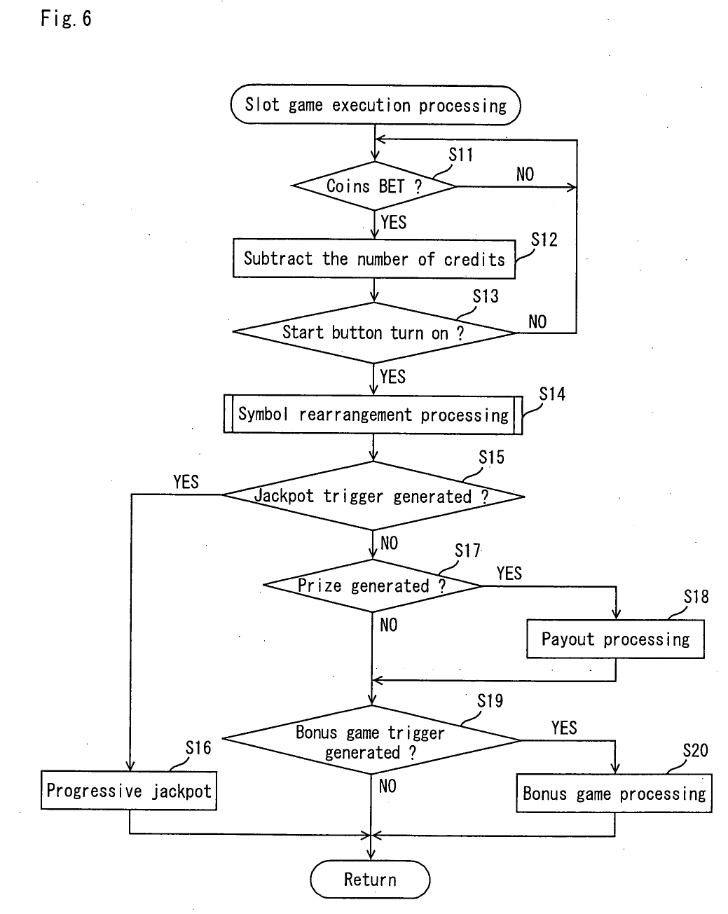

FIG. 6 is a flowchart showing a subroutine of a slot game execution processing.

In the slot game execution processing, the main CPU 41 at first determines whether or not a coin is BET (step S11). In the processing, the main CPU 41 determines whether an input signal output from the 1-BET switch 26S or the maximum BET switch 27S has been received or not when the 1-BET button 26 or the maximum BET button 27 is operated, respectively. If it is determined that a coin has not been BET, the process returns to step S11.

On the other hand, if it is determined in step S11 that a coin is BET, the main CPU 41 conducts a processing for subtracting the number of credits stored in RAM 43 according to the number of BET coins (step S12). In a case where the number of BET coins is more than the number of credits stored in RAM 43, the process returns to step S11 without conducting subtraction on the number of credits stored in RAM 43. In a case where the number of BET coins exceeds the upper limit (50 coins in the present embodiment) up to which a BET is possible in one game, the process advances to step S12 without conducting a processing for subtracting the number of BET coins from the number of credits stored in RAM 43. Further, the main CPU 41 cumulatively accumulates, in the RAM 43, a portion of the subtracted number of credits (for example, a predetermined ratio) as an accumulated value for a progressive jackpot.

Then, the main CPU 41 determines whether the start button 23 has been turned ON or not (step S13). In the processing, the main CPU 41 determines, when the start button 23 is pressed, whether an input signal output from the start switch 23S has been received or not.

If it is determined that the start button 23 has not been turned ON, the process returns to step S11. Note that in a case where the start button 23 has not been turned ON (for example, in a case where a command of terminating a game has been input without turning ON the start button 23), the main CPU 41 cancels a result of the subtracting processing in step S12.

On the other hand, if the main CPU 41 determines at the step S13 that the start button 23 has been turned ON, then the main CPU 41 conducts a symbol rearrangement processing (step S14).

Hereinafter, the symbol rearrangement processing will be described.

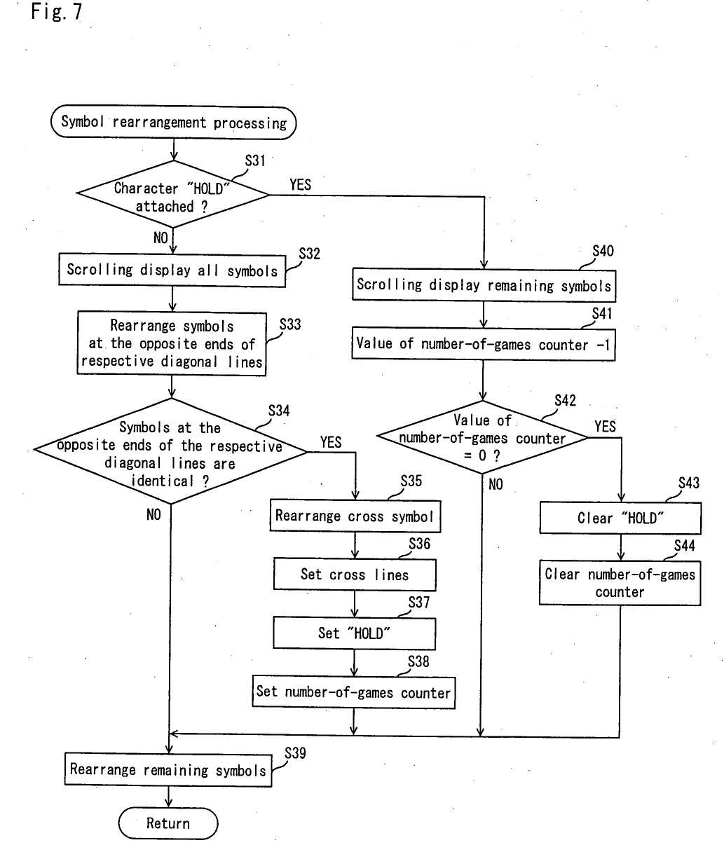

FIG. 7 is a flow chart illustrating a subroutine of the symbol rearrangement processing.

First, the main CPU 41 determines whether or not there is arranged, in the symbol matrix SM, a symbol having “HOLD” attached thereon (step S31).

If there is arranged no symbol with the character “HOLD” added thereon, the main CPU 41 starts scrolling display of all symbols included in the symbol matrix SM on the lower image display panel 16, as illustrated in FIG. 3A (step S32). At this time, 10 basic lines are set within the symbol matrix SM, regardless of the number of BETs.

Next, the main CPU 41 rearranges symbols at the opposite ends of the respective diagonal lines of the symbol matrix SM (step S33). In this processing, the main CPU 41 executes the aforementioned symbol selection program to determine the types of the four symbols to be rearranged at the opposite ends of the respective diagonal lines. Further, in determining the symbols to be rearranged, the symbols to be rearranged at the opposite ends of the respective diagonal lines can be determined at first, and then the remaining symbols can be determined. Also, all the symbols can be determined, then symbols can be rearranged at the opposite ends of the respective diagonal lines and, thereafter, symbols that are yet to be arranged can be rearranged.

Next, the main CPU 41 determines whether or not the symbols at the opposite ends of the respective diagonal lines are identical to each other (step S34). If the symbols at the opposite ends of the respective diagonal lines are identical to each other, a cross symbol having the function of these two types of symbols is arranged at the intersection of the respective diagonal lines (the cross lines) (step S35) and the cross lines that are set along the respective diagonal lines are determined (step S36). Further, the symbols at the opposite ends of the cross lines are held, and the character “HOLD” is attached on these symbols (step S37). Then, a number-of-games counter is set in the RAM 43 (step S38). While, in the present embodiment, there will be described a case where the number-of-games counter is set to “5”, the present invention is not limited to the case, as previously described. If it is determined, at the step S34, that the symbols at the opposite ends of the respective cross lines are not identical to each other or if the processing at the step S38 has been conducted, the main CPU 41 rearranges symbols that are yet to be arranged and that are included in the symbol matrix SM (step S39). Thereafter, the present subroutine ends and the processing is returned to the subroutine of FIG. 6.

On the other hand, if it is determined, at the step S31, that there is a symbol having “HOLD” attached thereon, the main CPU 41 starts scrolling display of symbols that are yet to be arranged and that are included in the symbol matrix SM (step S40), as illustrated in FIG. 3B. At this time, 10 basic lines BL are defined in the symbol matrix SM, regardless of the number of BETs. Thereafter, the count value of the number-of-games counter set in the RAM 43 is subtracted by one (step S41). Then, it is determined whether or not the number-of-games counter has a value of “0” (step S42). If the number-of-games counter has a value of “0”, the holding of the cross symbol and the symbols at the opposite ends of the cross lines is cleared (step S43) and, then, the count value of the number-of-games counter set in the RAM 43 is cleared (step S44). If it is determined, at the step S42, that the number-of-games counter does not have a value of “0” or if the processing at the step S44 has been conducted, the main CPU 41 rearranges symbols that are yet to be arranged and that are included in the symbol matrix SM (step S39). Thereafter, the present subroutine ends and the process is returned to the subroutine of FIG. 6.

After the process is returned from the subroutine of FIG. 7 to the subroutine of FIG. 6, the main CPU 41 determines whether or not a jackpot trigger has been established, namely whether or not an winning combination of “SMILE×5” has been established along a winning line (step S15). If it is determined that a jackpot trigger has been generated, a progressive jackpot is executed (step S16). The number of coins to be paid out based on a progressive jackpot corresponds to the accumulated value (a value resulted from accumulation of a portion of the number of inserted game media) stored in the RAM 43 plus an initial payout value, and the payout thereof is performed through hand-pay. At the step S16, the main CPU 41 conducts processing such as, for example, outputting of notification sound from a speaker 29, lighting of a lamp 30, printing of the ticket 39 with a bar code having a bar code indicating the number of coins to be paid out printed thereon. Thereafter, the present subroutine is terminated.

On the other hand, if the main CPU 41 determines, at the step S15, that no jackpot trigger has been generated, the main CPU 41 determines whether or not a prize has been generated (step S17). In this case, the generation of a prize means generation of at least one winning combination out of “JEWEL×5”, “SUN×5”, “MOON×5”, “STAR×5”, “HEART×5” and “RIBBON×3+ANY” along a winning line (see FIG. 2).

If the main CPU 41 determines that a prize has been generated, the main CPU 41 pays out coins, according to the number of coins to be paid out defined for the winning combination and the number of BETs (step S18). If the coins are to be accumulated, the main CPU 41 conducts processing for adding a predetermined number of credits to the number of credits stored in the RAM 43. On the other hand, if the coins are to be paid out, the main CPU 41 transmits a control signal to the hopper 66 to cause it to pay out a predetermined number of coins.

If it is determined, at the step S17, that no prize has been generated or if the processing at the step S18 has been conducted, the main CPU 41 determines whether or not a bonus game trigger has been generated, namely whether or not “CROWN×5” has been generated along a winning line (step S19). If the main CPU 41 determines that a bonus game trigger has been generated, the main CPU 41 reads, from the RAM 43, a program for executing a predetermined number of free games as a bonus game and executes a bonus game processing (step S20). If the main CPU 41 determines, at the step S19, that no bonus game trigger has been generated or if the processing at the step S20 has been conducted, the present subroutine is terminated.

As described above, the slot machine 10 according to the present embodiment includes the lower image display panel 16 having a symbol matrix SM for arranging a total of 5×5=25 symbols, wherein the symbol matrix SM can set 12 winning lines including two cross lines CL connecting the opposite corners of the symbol matrix SM to each other. Further, the slot machine 10 includes the main CPU 41 which rearranges symbols at the opposite ends of the respective diagonal lines of the symbol matrix SM at first, then sets the two cross lines CL and also rearranges at the intersection of the cross lines CL a cross symbol that is allowed to have the function of the two types of symbols rearranged at the opposite ends of the respective cross lines CL, if the symbols positioned at the opposite ends of the respective diagonal lines are identical. If a symbol rearranged along the cross line is identical to the symbols rearranged at the opposite ends of the cross line, the main CPU 41 conducts a high payout having a higher rate than a payout in an event that the symbol is rearranged at a position other than the cross line. Further, when the aforementioned controller rearranges a cross symbol, the controller holds the cross symbol during plural games.

Further, the slot machine 10 executes a slot machine playing method according to the present invention as follows.

The main CPU 41 rearranges symbols at the opposite ends of the respective diagonal lines of the symbol matrix SM to the lower image display panel 16, then sets the two cross lines CL connecting the opposite corners of the symbol matrix SM to each other and also rearranges a cross symbol which is allowed to have the function of the two types of symbols rearranged at the opposite ends of the respective cross lines CL if the symbols at the opposite ends of the respective diagonal lines are identical. At this time, if a symbol rearranged along the cross line is identical to the symbols rearranged at the opposite ends of the cross line, the main CPU 41 conducts a high payout having a higher rate than a payout in an event that the symbol is rearranged at a position other than the cross line. Further, when a cross symbol is rearranged, the cross symbol is held during plural games.

Although the embodiment according to the present invention is described, the description presents only some of the specific examples, and is not intended to limit the present invention in any way and specific constructions of each means and the like can be properly changed in terms of design. Besides, the effects described in the embodiment of the present invention are only the most preferable effects generated from the present invention and effects to be caused by the present invention is not limited to those described in the embodiment of the present invention.

There has thus been outlined, rather broadly, the more important features of the invention in order that the detailed description thereof aforementioned may be better understood, and in order that the present contribution to the art may be better appreciated. There are, of course, additional features of the invention that described above and which formed the subject matter of the claims appended hereto.

In this respect, above explaining at least one embodiment of the invention in detail, it is to be understood that the invention is not limited in its application to the details of construction and to the arrangements of the components set forth in the aforementioned description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art.

A procedure explained here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

What is claimed as new and desired to be secured by Letters Patent of the United States is:

1. A slot machine comprising:
a display having a rectangular display area to which a plurality of symbols are to be arranged and two cross lines are at least to be set, each of said cross lines connecting opposite corners of said display area; and
a controller,
said controller rearranging the plurality of symbols within said display area and
setting said two cross lines and rearranging a cross symbol at an intersection of said cross lines when the symbols rearranged on both ends of respective diagonal lines of said display area are the same, said cross symbol allowed to function as two types of symbols rearranged on both ends of the respective cross lines.

2. The slot machine according to claim 1,
wherein
said controller further comprises
conducting a high payout when a same symbol as the symbols rearranged on both ends of either one of said cross lines is rearranged on said one cross line, said high payout having a higher rate than a payout in an event that the same symbol is rearranged at a position other than the one cross line.

3. The slot machine according to claim 1,
wherein
said controller further comprises
holding said cross symbol during a plurality of games.

4. A slot machine comprising:
a display having a rectangular display area to which a plurality of symbols are to be arranged and two cross lines are at least to be set, each of said cross lines connecting opposite corners of said display area; and
a controller,
said controller rearranging the plurality of symbols within said display area,
setting said two cross lines and rearranging a cross symbol at an intersection of said cross lines when the symbols arranged on both ends of respective diagonal lines of said display area are the same, said cross symbol allowed to function as two types of symbols rearranged on both ends of the respective cross lines, and
conducting a high payout when a same symbol as the symbols rearranged on both ends of either one of said cross lines is rearranged on said one cross line, said high payout having a higher rate than a payout in an event that the same symbol is rearranged at a position other than the one cross line.

5. The slot machine according to claim 4,
wherein
said controller further comprises
holding said cross symbol during a plurality of games.

6. A slot machine comprising:
a display having a rectangular display area to which a plurality of symbols are to be arranged and two cross lines are at least to be set, each of said cross lines connecting opposite corners of said display area; and
a controller,
said controller rearranging the plurality of symbols within said display area,
setting said two cross lines and rearranging a cross symbol at an intersection of said cross lines when the symbols rearranged on both ends of respective diagonal lines of said display area are the same, said cross symbol allowed to function as two types of symbols rearranged on both ends of the respective cross lines,
conducting a high payout when the same symbols as the symbols rearranged on the both ends of either of said cross lines is rearranged on one of said cross lines, said high payout having a higher rate than a payout in an event that the symbol is rearranged at a position other than the cross line, and subsequently
holding said cross symbol during a plurality of games.

7. A playing method of a slot machine,
comprising the steps of:
rearranging symbols to a rectangular display area of a display; and
setting two cross lines connecting opposite corners of said display area and rearranging a cross symbol at the intersection of said cross lines when the symbols rearranged on both ends of respective diagonal lines of said display area are the same, said cross symbol allowed to function as two types of symbols rearranged at both ends of the respective cross lines, each of said steps conducted by a controller.

8. The playing method of a slot machine according to claim 7,
wherein
said controller further comprises
conducting a high payout when a same symbol as the symbols rearranged on both ends of either one of said cross lines is rearranged on said one cross line, said high payout having a high rate than a payout in an event that the same symbol is rearranged at a position other than the one cross line.

9. The playing method of a slot machine according to claim 7,
wherein
said controller further comprises
holding said cross symbol during a plurality of games.

10. A playing method of a slot machine,
comprising the steps of:
rearranging symbols to a rectangular display area of a display;
setting two cross lines connecting opposite corners of said display area and rearranging a cross symbol at the intersection of said cross lines when the symbols rearranged on both ends of respective diagonal lines of said display area are the same, said cross symbol allowed to function as two types of symbols rearranged at both ends of the respective cross lines; and
conducting a high payout when a same symbol as the symbols rearranged on both ends of either one of said cross lines is rearranged on said one cross line, said high payout having a higher rate than a payout in an event that the same symbol is rearranged at a position other than the one cross line, each of said steps conducted by a controller.

11. The playing method of a slot machine according to claim 10,
wherein
said controller further comprises
holding said cross symbol during a plurality of games.

12. A playing method of a slot machine,
comprising the steps of:
rearranging symbols to a rectangular display area of a display;
setting two cross lines connecting opposite corners of said display area and rearranging a cross symbol at the intersection of said cross lines when the symbols rearranged on both ends of respective diagonal lines of said display area are the same, said cross symbol allowed to function as two types of symbols rearranged at both ends of the respective cross lines; and
conducting a high payout when a same symbol as the symbols rearranged on the both ends of either one of said cross lines is rearranged on said one cross line, said high payout having a higher rate than a payout in an event that the same-symbol is rearranged at a position other than the one cross line,
followed by a step of holding said cross symbol during a plurality of games, each of said steps conducted by a controller.
